(19) United States
(12) Patent Application Publication
(10) Pub. No.: US 2020/0273315 A1
(43) Pub. Date: Aug. 27, 2020

(54) Remote Confined Work Space Monitoring System and Method

(71) Applicant: Impact Safety Solutions Ltd., Leduc (CA)

(72) Inventors: Darren Dean LaRocque, Edmonton (CA); Carey Shawn Chonkolay, Edmonton (CA); Roberto Alejandro Paredes, Edmonton (CA); David John Hamilton, Beaumont (CA)

(21) Appl. No.: 16/802,049

(22) Filed: Feb. 26, 2020

Related U.S. Application Data
(60) Provisional application No. 62/810,746, filed on Feb. 26, 2019.

(51) Int. Cl. G08B 21/16; H04M 11/02; H04N 7/14; G08B 5/38; G08B 29/18; G07C 9/29

(52) U.S. Cl. CPC G08B 21/16; H04M 11/025; G07C 9/29; G08B 5/38; G08B 29/181; H04N 7/147

(57) ABSTRACT

A system and method for remotely monitoring confined work spaces. The system can have subcomponents including a badging station for recording ingress and egress in and out of the work space, intercom systems for inside and outside of the work space, alarm systems inside and outside of the work space, cameras located inside and outside of the work space, and a gas detector for detecting gases in the work space. The subcomponents can be connected to a control panel that can relay data and communications to and from the subcomponents to a central dispatch center.

### PRIORITY STATEMENT & CROSS-REFERENCE TO RELATED APPLICATIONS

This application claims priority from U.S. Patent Application Ser. No. 62/810,746 entitled “Remote Confined Work Space Monitoring System and Method” and filed on Feb. 26, 2019, which is hereby incorporated by reference, in entirety, for all purposes.

### TECHNICAL FIELD OF THE INVENTION

The present disclosure is related to the field of remotely monitoring work activity in confined work spaces.

### BACKGROUND OF THE INVENTION

For the purposes of this description and the claims that follow, the term “confined work space” shall be defined as:
a) is large enough for personnel to enter fully and perform assigned work;
b) is not designed for continuous occupancy by personnel; and
c) has a limited or restricted means of entry or exit.

Confined work spaces can include underground vaults, tanks, storage bins, pits, diked areas, vessels, silos or other similar areas. By definition, a permit-required confined work space can comprise one or more of the following characteristics:
a) contains or has the potential to contain a hazardous atmosphere;
b) contains a material with the potential to engulf personnel who enters the space;
c) has an internal configuration that might cause personnel to be trapped or asphyxiated by inwardly converging walls or by a floor that slopes downward and tapers to a smaller cross-section; and
d) contains any other recognized serious safety or health hazards.

Conventionally, the supervision and monitoring of work activity in a confined work space, which is defined as any space that may be injurious by reason of oxygen deficiency, flammability, explosivity or toxicity, is performed by using a human physically located in the loop approach. In this approach, a person is required to perform a safety watch of the work being performed by another worker located inside a confined work space, which can include enclosed vessels of varying types and sizes. This safety watch procedure is an essential legal or regulatory requirement for achieving governmental certification for the confined work space. However, the person responsible for performing the safety watch is positioned outside the confined work space and is not allowed to break the plane of entrance to the confined work space. As a result, all communication between the safety watch and the worker in the confined work space is performed verbally, which can create a very inefficient system as the safety watch does not have any visual feedback of the exact situation inside the confined work space and cannot react in time to an emergency concerning the work in the confined work space. Prior to the development of the system and method described herein, a remote monitoring system for confined work spaces that comply with Class 1 specifications was not previously available.

It is, therefore, desirable to provide a remote monitoring system for confined work spaces that can be used in hazardous locations.

### SUMMARY OF THE INVENTION

A system and a method of remotely monitoring the ingress, egress and activity inside a confined work space is provided.

In some embodiments, a system and method can be provided to remove, change or centralize the location of a human attendant for monitoring confined work spaces with a remote system having zero error. In some embodiments, a process can be provided for converting an extremely critical task performed by a human attendant to a higher level of efficiency and safety by utilizing advanced levels of technology. In some embodiments, the system and method can comprise an integration of various discrete technologies to develop a system capable of operating in confined work spaces with the potential of becoming hazardous locations. In some embodiments, the system can be explosion-proof, while meeting extremely stringent specifications. In some embodiments, the system can comprise a communication system, infra-red cameras, continuous gas detection sensors, an access control system for ingress and egress to and from the confined work space, and various sensors and alarms for monitoring environmental and other parameters within the confined work space.

In some embodiments, the system and method for remote monitoring of confined work spaces can minimize human error or congestion, reduce risks, obtain real time measurements and maximize safety in the confined work space.

In some embodiments, the system and method described herein can comply with strict Class 1, Division 2 requirements and can comprise a hazardous location (“HL”) rating, which is required for accurate detection and warning of oxygen deficiency, flammability, explosivity or toxicity. In some embodiments, the system and method can comprise various modern technological systems as sub-components, each of which can address individual regulatory requirements and specifications, integrated into a single platform.

In some embodiments, the system and method can comprise a software platform designed by Genetec Inc. of Montreal, Canada for integrating and connecting the hardware components of the system to a central control centre for monitoring and controlling the hardware sub-components. In other embodiments, the system and method can comprise software designed by Avigilon™ of Vancouver, Canada for integrating and connecting the hardware components of the system to a central control centre for monitoring and controlling the hardware sub-components.

In some embodiments, the system and method can comprise a gas detection system, with its sub-components modified or adapted to integrate it into the system and method, wherein the system can be compatible with Class 1, Division 2 specifications of the Canadian Electrical Code as published by the Canadian Standards Association (“CSA”). In some embodiments, the system and method can comprise an automated access control system for controlling access to the confined work space by personnel, wherein the system and method can manage congestion of same. The existing manual approach, which requires workers to physically sign in or out when entering or exiting the confined work space is inefficient in terms of managing the time and tracking worker activity. In some embodiments, the system and method can comprise radio frequency identification (“RFID”) tagged badges, which can automate a sign-in process for entering the confined work space and can further automate a sign-out process for exiting the confined work space. In some embodiments, the RFID badges can enable the software to efficiently monitor worker activity and can improve the scheduling of work, wherein greater productivity and planning can be achieved over a manual approach for work scheduling.

In some embodiments, the system and method can comprise cameras and sensors rated for use in Class 1 applications. In some embodiments, the system and method can comprise interconnect cables for operatively coupling sub-components and peripherals used in the system that conform to CSA's Class 1, Division 2 electrical ratings for operating in hazardous environments. In some embodiments, the system and method can comprise a plurality of cable configurations, depending on their purpose and application in the system. By providing different cable configurations for different applications, the misconnecting of sub-components together that are not to be connected together can be avoided. In some embodiments, connectors and cables comprising 2 pins/conductors can be used for intercom connections. In some embodiments, connectors and cables comprising 4 pins/conductors can be used for power connections. In some embodiments, connectors and cables comprising 5 pins/conductors can be used for visual indicator (“LED”) connections. In some embodiments, connectors and cables comprising 6 pins/conductors can be used for audible alarm connections. In some embodiments, connectors and cables comprising 7 pins/conductors can be used for RFID reader connections. In some embodiments, the system can comprise Ethernet® cables and connectors can be used for camera connections.

In some embodiments, the system and method can comprise at least one explosion-proof enclosure for controlling, isolating and housing the hardware and electronic sub-components of the system. In some embodiments, the enclosure can be configured for portability. In some embodiments, to reduce weight, the enclosure can be configured for housing only the critical sub-components. To further reduce weight, the enclosure can be configured with a reduced volume of cabling and electrical connections. In some embodiments, the enclosure can be configured with different materials, electrical connections, terminal strips, port arrangements, battery size and so on.

In some embodiments, the system and method can comprise gas detection sub-components that can accurately detect the levels of various gases, which can include oxygen (“O₂”), carbon monoxide (“CO”), carbon dioxide (“CO₂”), lower explosive limit (“LEL”) gases, sulphur dioxide (“SO₂”), hydrogen sulphide (“H₂S”) and ammonia (“NH₃”), within the confined work space.

Broadly stated, in some embodiments, a system can be provided for remotely monitoring a confined work space, the system comprising: a control panel configured for installation at a work site comprising the confined work space, the control panel further configured for communication with a central dispatch center (“CDC”); a badging station operatively connected to the control panel, the badging station configured for installation external to the confined work space and proximate to an entrance to the confined work space, the badging station comprising an ingress badge reader and an egress badge reader configured for monitoring ingress and egress into and out of the confined work space, the ingress badge reader configured for generating ingress data, the egress badge reader configured for generating egress data, the badging station further configured to transmit the ingress data and the egress data to the control panel; an internal intercom system operatively coupled to the control panel, the internal intercom system configured for installation inside of the confined work space, the internal intercom system further configured for transmitting and receiving internal audible communication with the control panel; an internal alarm system operatively coupled to the control panel, the internal alarm system configured for installation inside of the confined work space, the internal alarm system further configured to emit an internal alarm when working conditions at the work site or in the confined work space are unsafe; and an internal camera operatively coupled to the control panel, the internal camera configured for installation inside of the confined work space, the internal camera further configured for transmitting internal images of the confined work space to the control panel

Broadly stated, in some embodiments, the system can further comprise an external intercom system operatively coupled to the control panel, the external intercom system configured for installation outside of the confined work space, the external intercom system further configured for transmitting and receiving external audible communications with the control panel; and an external camera operatively coupled to the control panel, the external camera configured for installation outside of an entrance to the confined work space, the external camera further configured for transmitting external images to the control panel.

Broadly stated, in some embodiments, the system can further comprise a gas detector operatively coupled to the control panel, the gas detector configured to detect one or more gases in the confined work space, the gas detector further configured to generate and transmit gas detection data to the central dispatch center when the one or more gases are detected in the confined work space.

Broadly stated, in some embodiments, the system can further comprise a communications link to the central dispatch center, wherein the communications link is configured to facilitate transmission of one or more of the ingress data, the egress data, the internal audible communication, the internal alarm and the internal images to or from the central dispatch center.

Broadly stated, in some embodiments, the system can further comprise a communications link to the central dispatch center, wherein the communications link is configured to facilitate transmission of one or more of the external audible communication and the external images to or from the central dispatch center.

Broadly stated, in some embodiments, the internal intercom system can further comprise a first strobe light configured to illuminate when the internal intercom system is operating.

Broadly stated, in some embodiments, the internal alarm system can further comprise one or both of a first audible alarm siren and a second strobe light, both of which are configured to operate during the internal alarm.

Broadly stated, in some embodiments, the external intercom system can further comprise a visual indicator configured to illuminate when the external intercom system is operating.

Broadly stated, in some embodiments, one or more of the control panel, the badging station, the internal intercom system, the internal alarm system, the internal camera, the external intercom system, the external alarm system and the external camera can be disposed in hazardous location-rated enclosures.

Broadly stated, in some embodiments, one or more of the external intercom system and the external camera can be disposed in hazardous location-rated enclosures.

Broadly stated, in some embodiments, the control panel can further comprise: an access controller configured for communication with the central dispatch center; a power over ethernet (“POE”) switch configured to operatively connect one or more of the badging station, the internal intercom system, the internal alarm system, the internal camera, the external intercom system and the external camera to the access controller; a power supply operatively coupled to the access controller and to the POE switch; and a back-up battery operatively coupled to the power supply.

Broadly stated, in some embodiments, the access controller can be disposed inside of an explosion-proof controller enclosure.

Broadly stated, in some embodiments, a method can be provided for monitoring a confined work space, the method comprising: installing a system at a work site comprising the confined work space, the system configured for remotely monitoring the confined work space, the system comprising: a control panel configured for installation at a work site comprising the confined work space, the control panel further configured for communication with a central dispatch center; a badging station operatively connected to the control panel, the badging station configured for installation external to the confined work space and proximate to an entrance to the confined work space, the badging station comprising an ingress badge reader and an egress badge reader configured for monitoring ingress and egress into and out of the confined work space, the ingress badge reader configured for generating ingress data, the egress badge reader configured for generating egress data, the badging station further configured to transmit the ingress data and the egress data to the control panel; an internal intercom system operatively coupled to the control panel, the internal intercom system configured for installation inside of the confined work space, the internal intercom system further configured for transmitting and receiving internal audible communication with the control panel; an internal alarm system operatively coupled to the control panel, the internal alarm system configured for installation inside of the confined work space, the internal alarm system further configured to emit an internal alarm when working conditions at the work site or in the confined work space are unsafe; and an internal camera operatively coupled to the control panel, the internal camera configured for installation inside of the confined work space, the internal camera further configured for transmitting internal images of the confined work space to the control panel; monitoring ingress and egress of personnel into and out of the confined work space with the badging station; if verbal communication is to be made with the personnel in the confined work space, then communicating with the personnel via the internal intercom system; and if working conditions at the work site or in the confined work space are unsafe, then emitting the internal alarm via the internal alarm system.

Broadly stated, in some embodiments, the method can further comprise: if verbal communication is to be made with personnel located outside of the confined work space, then communicating with said personnel via the external intercom system.

Broadly stated, in some embodiments, the method can further comprise: installing a gas detector proximate to the confined work space, the gas detector configured to detect one or more gases in the confined work space, the gas detector further configured to generate and transmit gas detection data to the control panel when the one or more gases are detected in the confined work space; and if the one or more gases are detected in the confined work space by the gas detector, then transmitting the gas detection data to the central dispatch center.

Broadly stated, in some embodiments, the method can further comprise transmitting one or more of the ingress data, the egress data, the internal audible communication, the internal alarm, the internal images and the gas detection data to or from the central dispatch center.

Broadly stated, in some embodiments, the method can further comprise transmitting one or more of the external audible communication and the external images to or from the central dispatch center.

Broadly stated, in some embodiments, wherein communicating via the internal intercom system can comprise illuminating a first strobe light disposed in the confined work space.

Broadly stated, in some embodiments, wherein emitting the internal alarm can comprise one or more of sounding a first audible alarm siren and illuminating a second strobe light.

Broadly stated, in some embodiments, wherein communicating via the external intercom system can comprise illuminating a visual indicator.

### BRIEF DESCRIPTION OF THE DRAWINGS

FIG. 1 is a block diagram depicting one embodiment of a remote confined work space monitoring system.

FIG. 2 is a simplified block diagram depicting the system of FIG. 1.

FIG. 3 is a front elevation view depicting one embodiment of a badging station of the system of FIG. 1.

FIG. 4 is a front elevation view depicting one embodiment of an intercom system of the system of FIG. 2.

FIG. 5 is a front elevation view depicting one embodiment of an alarm system of the system of FIG. 2.

FIG. 6 is a perspective view depicting one embodiment of a camera of the system of FIG. 2.

FIG. 7 is a front elevation view depicting one embodiment of a gas detector of the system of FIG. 1.

FIG. 8 is a perspective view depicting one embodiment of a cable assembly for use with the system of FIG. 1.

FIG. 9 is a perspective view depicting one embodiment of an ethernet cable assembly for use with the system of FIG. 1.

FIG. 10 is a front elevation view depicting one embodiment of a control panel of the system of FIG. 1.

### DETAILED DESCRIPTION OF THE INVENTION

In this description, references to “one embodiment”, “an embodiment”, or “embodiments” mean that the feature or features being referred to are included in at least one embodiment of the technology. Separate references to “one embodiment”, “an embodiment”, or “embodiments” in this description do not necessarily refer to the same embodiment and are also not mutually exclusive unless so stated and/or except as will be readily apparent to those skilled in the art from the description. For example, a feature, structure, act, etc. described in one embodiment can also be included in other embodiments, but is not necessarily included. Thus, the present technology can include a variety of combinations and/or integrations of the embodiments described herein.

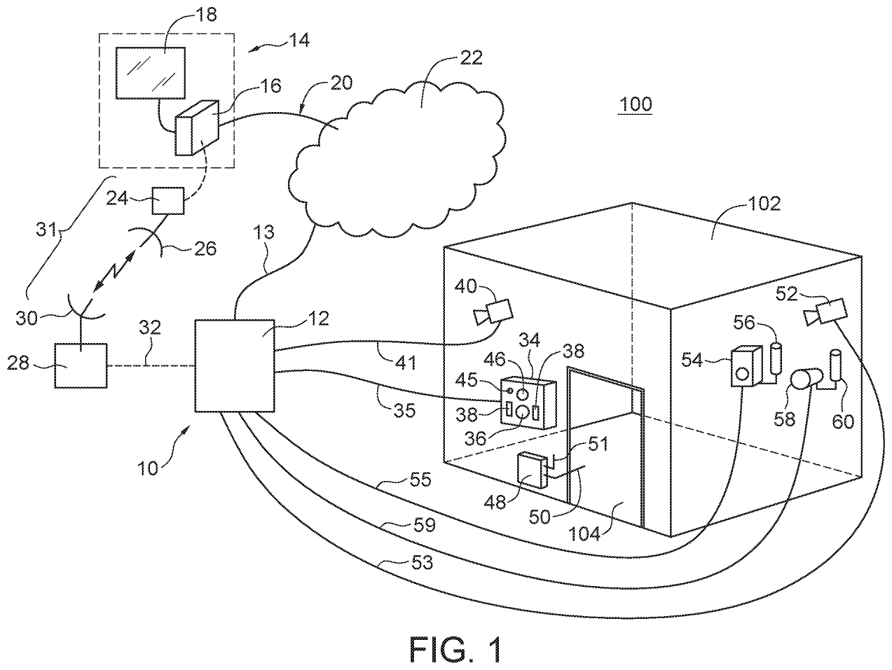

Referring to FIG. 1, one embodiment of a remote confined space monitoring system is shown. In some embodiments, monitoring system 10 can comprise of control panel 12 located at work site 100 comprising confined work space 102. For the purposes of this description and the claims that follow, the term “confined work space” shall mean any work space that is enclosed or confined and requires monitoring when personnel are in the work space, whether the monitoring is required by law or not in the jurisdiction where the work space is located. Such work spaces can include, but is not limited to, enclosed structures such as isolated rooms, vessels and any other enclosed environment at the work site as well known to those skilled in the art.

In some embodiments, control panel 12 can be in communication with central dispatch center (“CDC”) 14 that can be configured to monitor confined work space 102 from a location remote from work site 100. In some embodiments, control panel 12 can be configured to be installed in, and operate in, a hazardous location or environment wherein control panel 12 must comply with Class 1, Division 2 regulations. In some embodiments, control panel 12 can communicate with CDC 14 via wire communications links 13 and 20 via communications network 22. Communications network can comprise a public switched telephone network, a global computer network (such as the “internet”), a private telecommunications network or any other communications network as well known to those skilled in the art. CDC 14 can comprise general purpose computer 16 operatively coupled to monitor 18, wherein computer 16 can run monitoring software as described above.

In some embodiments, control panel 12 can operatively communicate with CDC 14 over a dedicated microwave communications link 21 comprising radio transceiver 28 and antenna 30 operatively coupled to control panel 12 and radio transceiver 24 and antenna 26 operatively couple to computer 16, wherein a microwave radio communications link is established between antennas 26 and 30. In some embodiments, the radio communications system can comprise a model 450i radio system as manufactured by Cambian Networks of Rolling Hills, Ill., U.S.A. In some embodiments, the radio system can be disposed in HazLo™ model explosion-proof enclosures as manufactured by Adalet of Cleveland, Ohio, U.S.A.

In some embodiments, system 10 can comprise badging station 34 disposed near or proximate to entrance 104 of confined work space 102. Badging station 34 can comprise card reader 38 configured for reading an identification card (“ID”) of a worker, the ID card having an RFID chip disposed therein, or any other form of ID technology as well known to those skilled in the art, uniquely identifying the worker. In some embodiments, badging station 34 can comprise a dedicated card reader 38 for reading the ID card when the worker wishes to enter confined work space 102, and another card reader 38 for reading the ID card when the worker leaves confined work space 102. In some embodiments, card reader 38 can comprise a model RP15e card reader as manufactured by HID Global Corporation of Austin, Texas, U.S.A. In some embodiments, badging station 34 can be operatively coupled to control panel 12 via communication link 35. In some embodiments, communications link 35 can comprise one or more of a cable having wire conductors, an optical fiber, a wireless communications link and any other communications connection as well known to those skilled in the art.

In some embodiments, badging station 34 can further comprise external intercom 46 to enable personnel to communicate with CDC supervisory personnel located at CDC 14. Intercom 46 can further comprise control panel 36 comprising electrical buttons or controls configured to initiate and receive audible or verbal communications with personnel at CDC 14. In some embodiments, control panel 36 can comprise visual indicator 45 that can illuminate when intercom 46 is in operation. In some embodiments, visual indicator 45 can comprise at least one light emitting diode (“LED”). In some embodiments, external intercom 46 can comprise an optional powered loudspeaker with a volume control, as well known to those skilled in the art, to increase or decrease the audio volume of the intercom to enable the intercom to be heard over or above the background noise in the surrounding area.

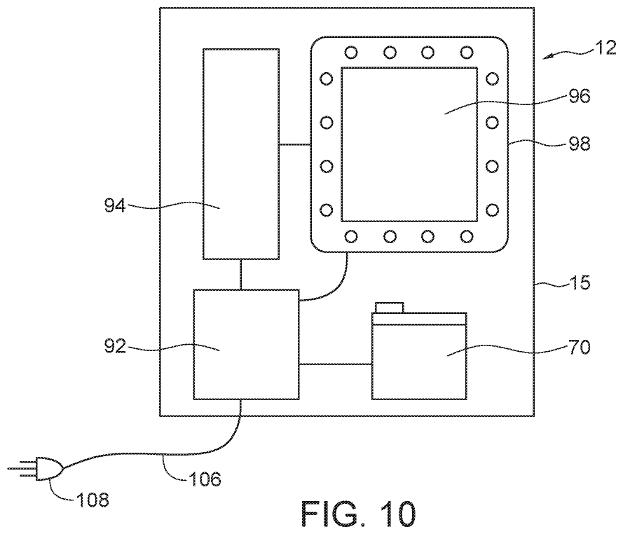

In some embodiments, system 10 can comprise external camera 40 disposed outside of entrance 104 for visually monitoring activity outside of work space 102. External camera 40 can be operatively coupled to control panel 12 via communications link 41, which can comprise providing electrical power over an ethernet cable that can couple camera 40 to PoE switch 94 disposed in control panel 12 (as shown in FIG. 10).

In some embodiments, system 10 can comprise internal intercom 54 configured for installation inside work space 102, wherein internal intercom 54 can be operatively coupled to control panel 12 via communications link 55. Internal intercom 54 can further comprise internal intercom light 56 configured to illuminate when internal intercom 54 is operation to provide a visual indication of same or to provide a visual indication that personnel at CDC 14 wants to initiate verbal communication with personnel inside work space 102. In some embodiments, internal intercom light 56 can emit white light when it is illuminated. In some embodiments, internal intercom 54 can comprise an optional powered loudspeaker with a volume control, as well known to those skilled in the art, to increase or decrease the audio volume of the intercom to enable the intercom to be heard over or above the background noise in the surrounding area.

In some embodiments, system 10 can comprise internal camera 52 disposed inside work space 102 for visually monitoring personnel inside work space 102. Internal camera 52 can be operatively coupled to control panel 12 via communications link 53, which can comprise an ethernet cable that can couple camera 52 to PoE switch 94 disposed in control panel 12 (as shown in FIG. 10). In some embodiments, system 10 can comprise internal alarm siren 58 operatively coupled to control panel 12 via communications link 59. Internal siren 58 can further comprise internal alarm strobe light 60 whereupon an alarm condition occurring, either in work space 102 or at work site 100, an audible and a visual alarm signal can be emitted to alert work personnel inside work space 102 of the alarm condition so that they can then take the necessary steps in response to the alarm, whether that be evacuating work space 102 and/or work site 100 or any other procedure as required. In some embodiments, internal alarm strobe light 60 can emit red light so as to provide a different visual signal than internal intercom light 56 to indicate an alarm versus an intercom communication.

In some embodiments, system 10 can comprise gas detector 48 configured for detecting gases inside or near work space 102. In some embodiments, gas detector 48 can comprise sniffer tube 50 configured to detect gases inside work space 102, and be further configured to detect oxygen (“O₂”), carbon monoxide (“CO”), carbon dioxide (“CO₂”), lower explosive limit (“LEL”) gases, sulphur dioxide (“SO₂”), hydrogen sulphide (“H₂S”) and ammonia (“NH₃”). In some embodiments, gas detector 48 can be operatively coupled to control panel 12 via communications link 51, which can include one or more of a wired cable communications link and a wireless radio communications link such as Wi-Fi® or equivalent wireless communications technology as well known to those skilled in the art. For operation in a Class 1, Division 2 environment, link 51 can comprise a wireless radio communications link. Representative embodiments of gas detector 48 can comprise a Dräger X Zone 5500 model gas detector as manufactured by Drägerwerk AG & Co. KGaA of Lubeck, Germany or an AreaRAE Plus™ model detector as manufactured by Honeywell Analytics Distribution Inc. of Lincolnshire, Ill., U.S.A.

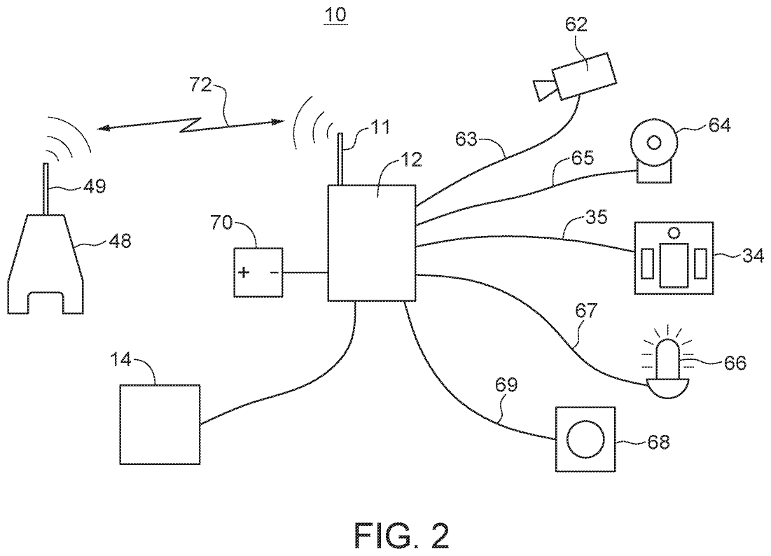

Referring to FIG. 2, a simplified block diagram of system 10 as would be installed at a work site is shown. In this figure, system 10 can comprise one or more cameras 62, operatively coupled to control panel 12 via communications link 63, for providing video images to CDC 14. System 10 can further comprise one or more alarm sirens 64, operatively coupled to control panel via communications link 65, for emitting audible alarms in response to commands provided by CDC 14 when an alarm condition is present in a confined work space or at the work site in general. System 10 can further comprise one or more badging stations 34, operatively coupled to control panel 12 via communications link 35, for monitoring ingress and egress to and from confined work spaces 102 and relaying that information to CDC 14. System 10 can comprise one or more intercom systems 68, operatively coupled to control panel 12 via communications link 69, to provide a verbal communications system between CDC 14 and one of the intercom systems. System 10 can further comprise one or more strobe lights or beacons 66, operatively coupled to control panel 12 via communications link 67, for illuminating when one of the intercom systems is in operation or when an alarm condition is present in a confined work space or at the work site in general. System 10 can further comprise one or more gas detectors 68, operatively coupled to control panel 12 via wireless radio communications link 72 facilitated between antenna 49 disposed on gas detector 48 and antenna 11 disposed on control panel 12 or to directly to CDC 14.

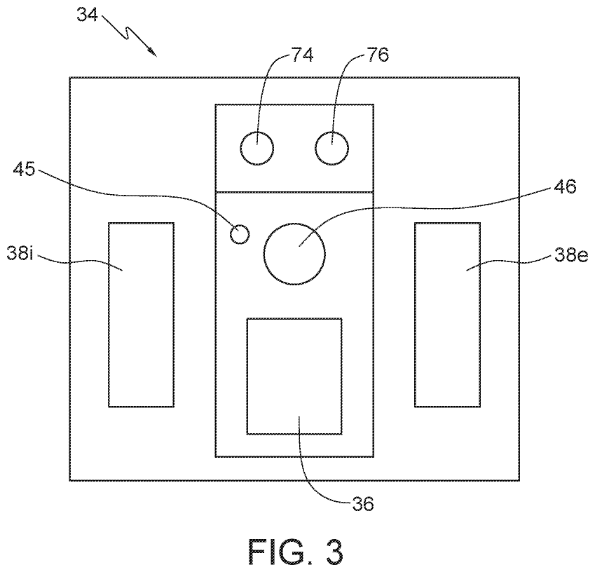

Referring to FIG. 3, one embodiment of badging station 34 is shown, which can be installed adjacent to a confined work space for monitoring ingress and egress in and out of the work space. In some embodiments, badging station 34 can comprise ingress card reader 38i for reading personnel ID cards of workers prior to their entering the work space. In some embodiments, badging stations 34 can comprise egress card reader 38e for reading personnel ID cards of workers when they leave the work space. In some embodiments, badging station 34 can comprise no-access light or indicator 74, which can illuminate when no access is permitted into the work space or to remain illuminated or flash after an ID card has been swiped across card reader 38i to indicate that the worker associated with the ID card is not permitted to enter the work space. In some embodiments, badging station 34 can comprise access-permitted light or indicator 76, which can illuminate or flash after an ID card has been swiped across card reader 38i to indicate that the worker associated with the ID card is permitted to enter the work space. In some embodiments, badging station 34 can compile the reading of ID cards by card reader 38i as ingress data in addition to compile the reading of ID cards by card reader 38e as egress data, wherein one or both of the ingress data and the egress data can be relayed to CDC 14 via control panel 12. In some embodiments, badging station 34 can comprise external intercom system 46 that can facilitate audio communication with CDC 14 via control panel 12. In some embodiments, external intercom system 46 can comprise control panel 36 for initiating or receiving audible or verbal communication with CDC 14.

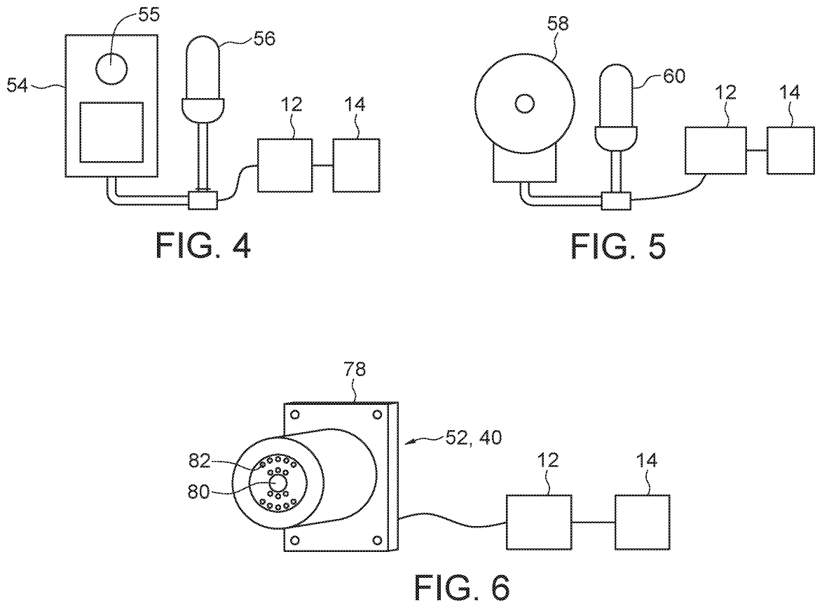

Referring to FIG. 4, one embodiment of internal intercom system 54 is shown, wherein internal intercom system 54 can be configured for installation in a confined work space and to facilitate audio communication with CDC 14 via control panel 12. In some embodiments, internal intercom system 54 can comprise beacon 55 that can illuminate when internal intercom system 54 is in operation. In some embodiments, internal intercom system 54 can comprise strobe light 56 that can illuminate and/or flash to provide a visual signal to workers in the work space that CDC 14 is calling internal intercom system 54.

Referring to FIG. 5, one embodiment of internal alarm siren 58 is shown, wherein internal alarm siren can be configured for installation in a confined work space and to emit an audible alarm in response to an alarm signal generated by CDC 14 when CDC 14 detects an alarm condition present in the work space, in another work space or at the work site in general. In some embodiments, internal alarm siren 58 can further comprise alarm strobe light 60 that can illuminate and/or flash to provide a visual signal to workers in the work space that an alarm condition is present.

Referring to FIG. 6, one embodiment of camera 40 or 52 is shown, wherein the camera can be configured for installation inside or outside of a confined work space. In some embodiments, camera 40 or 52 can comprise infrared (“IR”) light emitting diodes (“LED”) 82 for illuminating the viewing area of the camera with IR light in addition to IR camera device 80, which is sensitive to IR light, thereby enabling the camera to generate images illuminated with IR light when there is insufficient visible light for illuminating the viewing area. Video images captured by camera 40 or 52 can be relayed to CDC 14 via control panel 12. Camera 40 or 52 can further comprise IS enclosure 78 for enclosing IR camera device 80 and IR LEDs 82 to enable the installation of the camera in hazardous locations requiring equipment to comply with Class 1, Division 2 regulations.

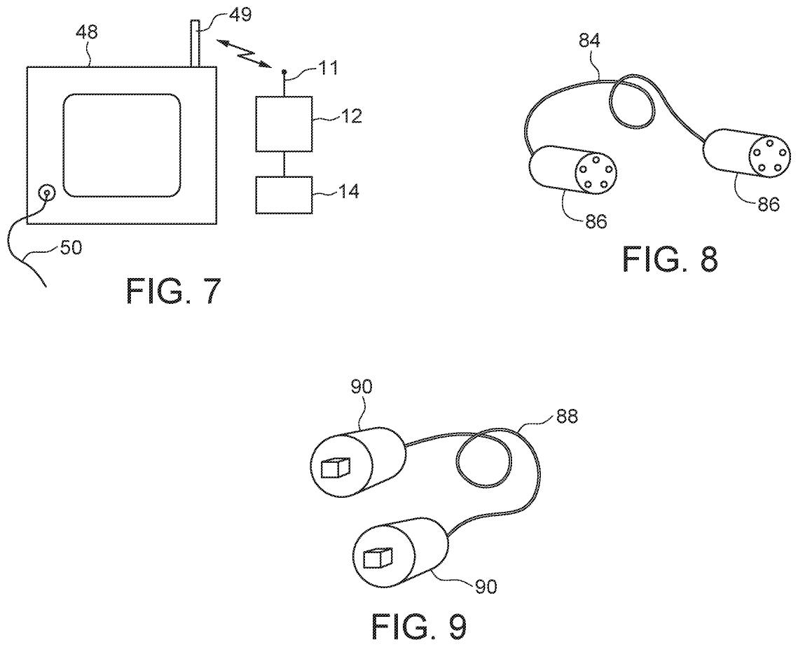

Referring to FIG. 7, one embodiment of gas detector 48 is shown. In some embodiments, gas detector 48 can comprise sniffer tube 50 configured to draw in air to detect whether certain gases are present and generate gas detection data when such gases are detected. Gas detector 48 can relay the gas detection data to CDC 14 via control panel 12. In some embodiments, gas detector 48 can further comprise a temperature sensor for detecting the temperature in the area surrounding gas detector 48, wherein temperature data can be relayed to CDC 14 in addition to the gas detection data.

Referring to FIG. 8, one embodiment of wire cable assembly 84 is shown, which can be used for any one of communication links 32, 35, 51, 55, 59, 65, 67 and 69. In some embodiments, cable assembly can comprise HL-rated electrical connectors 86 on either end of the assembly to enable it to be used in hazardous locations requiring the use of electrical equipment that complies with Class 1, Division 2 regulatory requirements. In some embodiments, cable assemblies for a specific communications can comprise a specific or predetermined conductor or pin count so that cable connections for specific communication links cannot inadvertently connected to the wrong piece of equipment or connection on control panel 12. In some embodiments, each cable assembly for a specific communications link can comprise a specific colour for the specific link as a means to prevent cable assemblies being inadvertently connected to the wrong piece of equipment or connection on control panel 12.

Referring to FIG. 9, one embodiment of ethernet cable assembly 88 is shown, which can be used for any one of communication links 41, 53 and 63 to connect a camera to control panel 12. In some embodiments, each cable assembly 88 can comprise an ethernet cable with HL-rated cable connectors 90 on each end of the cable to enable it to be used in hazardous locations requiring the use of electrical equipment that complies with Class 1, Division 2 regulatory requirements. In some embodiments, each cable assembly 88 can comprise an ethernet cable to provide power to each camera connected to control panel 12 via the cable assembly in addition to providing the medium for video images to be transmitted from the camera to control panel 12.

Referring to FIG. 10, one embodiment of control panel 12 is shown. In some embodiments, control panel 12 can comprise enclosure 15 wherein access controller 96, PoE switch 94, power supply and back-up battery 70 can be disposed therein. In some embodiments, access controller 96 can comprise a Vertx EVO V2000 model access control processing and host interface unit as manufactured by HID Global Corporation of Austin, Tex., U.S.A., wherein access controller 96 can be configured to interface with each piece of peripheral equipment of system 10 including, but not limited to, radio transceiver 28, badging station 34, external intercom system 46, external camera 40, gas detector 48, internal camera 52, internal intercom 54, internal intercom strobe 56, internal alarm siren 58 and internal alarm strobe 60. In some embodiments, access controller 96 can be disposed in explosion-proof enclosure 98. In some embodiments, external camera 40 and internal camera 52 can be disposed in explosion-proof enclosures. In a representative embodiments, these explosion-proof enclosures can comprise model HazLo™ model explosion-proof enclosures as manufactured by Adalet of Cleveland, Ohio, U.S.A. In some embodiments, control panel 12 can comprise PoE switch 94 operatively coupled to control 96, wherein PoE switch 94 can provide the interface between ethernet-connected equipment, such as cameras 40, 52 and 62 among any other ethernet-connected equipment, and access controller 96. In some embodiments, control panel can comprise power supply 92 that can rectify alternating current (“AC”) electrically power provided through power cable 106 connected to an AC power receptacle via connector 108 to provide the necessary direct current (“DC”) power required for the operation of access controller 96 and PoE switch 94. In some embodiments, power supply 92 can be operatively coupled to backup batter 70, which can be configured to provide power to power supply in the event of an AC power failure. In a representative embodiment, battery 70 can comprise an Amp-Hour capacity to provide power to power supply 92 for 60 minutes in the event of an AC power failure, although the Amp-Hour capacity of battery 70 can be increased or decreased to suit the requirements of system 10, as well known to those skilled in the art.

The various illustrative logical blocks, modules, circuits, and algorithm steps described in connection with the embodiments disclosed herein can be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans can implement the described functionality in varying ways for each particular application, but such implementation decisions should not be interpreted as causing a departure from the scope of the embodiments described herein.

Embodiments implemented in computer software can be implemented in software, firmware, middleware, microcode, hardware description languages, or any combination thereof. A code segment or machine-executable instructions can represent a procedure, a function, a subprogram, a program, a routine, a subroutine, a module, a software package, a class, or any combination of instructions, data structures, or program statements. A code segment can be coupled to another code segment or a hardware circuit by passing and/or receiving information, data, arguments, parameters, or memory contents. Information, arguments, parameters, data, etc. can be passed, forwarded, or transmitted via any suitable means including memory sharing, message passing, token passing, network transmission, etc.

The actual software code or specialized control hardware used to implement these systems and methods is not limiting of the embodiments described herein. Thus, the operation and behavior of the systems and methods were described without reference to the specific software code being understood that software and control hardware can be designed to implement the systems and methods based on the description herein.

When implemented in software, the functions can be stored as one or more instructions or code on a non-transitory computer-readable or processor-readable storage medium. The steps of a method or algorithm disclosed herein can be embodied in a processor-executable software module, which can reside on a computer-readable or processor-readable storage medium. A non-transitory computer-readable or processor-readable media includes both computer storage media and tangible storage media that facilitate transfer of a computer program from one place to another. A non-transitory processor-readable storage media can be any available media that can be accessed by a computer. By way of example, and not limitation, such non-transitory processor-readable media can comprise RAM, ROM, EEPROM, CD-ROM or other optical disk storage, magnetic disk storage or other magnetic storage devices, or any other tangible storage medium that can be used to store desired program code in the form of instructions or data structures and that can be accessed by a computer or processor. Disk and disc, as used herein, include compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm can reside as one or any combination or set of codes and/or instructions on a non-transitory processor-readable medium and/or computer-readable medium, which can be incorporated into a computer program product.

Although a few embodiments have been shown and described, it will be appreciated by those skilled in the art that various changes and modifications can be made to these embodiments without changing or departing from their scope, intent or functionality. The terms and expressions used in the preceding specification have been used herein as terms of description and not of limitation, and there is no intention in the use of such terms and expressions of excluding equivalents of the features shown and described or portions thereof, it being recognized that the invention is defined and limited only by the claims that follow.

What is claimed is:

1. A system for remotely monitoring a confined work space, the system comprising:
a control panel configured for installation at a work site comprising the confined work space, the control panel further configured for communication with a central dispatch center (“CDC”);
a badging station operatively connected to the control panel, the badging station configured for installation external to the confined work space and proximate to an entrance to the confined work space, the badging station comprising an ingress badge reader and an egress badge reader configured for monitoring ingress and egress into and out of the confined work space, the ingress badge reader configured for generating ingress data, the egress badge reader configured for generating egress data, the badging station further configured to transmit the ingress data and the egress data to the control panel;
an internal intercom system operatively coupled to the control panel, the internal intercom system configured for installation inside of the confined work space, the internal intercom system further configured for transmitting and receiving internal audible communication with the control panel;
an internal alarm system operatively coupled to the control panel, the internal alarm system configured for installation inside of the confined work space, the internal alarm system further configured to emit an internal alarm when working conditions at the work site or in the confined work space are unsafe; and
an internal camera operatively coupled to the control panel, the internal camera configured for installation inside of the confined work space, the internal camera further configured for transmitting internal images of the confined work space to the control panel.

2. The system as set forth in claim 1, further comprising:
an external intercom system operatively coupled to the control panel, the external intercom system configured for installation outside of the confined work space, the external intercom system further configured for transmitting and receiving external audible communications with the control panel; and
an external camera operatively coupled to the control panel, the external camera configured for installation outside of an entrance to the confined work space, the external camera further configured for transmitting external images to the control panel.

3. The system as set forth in claim 1, further comprising a gas detector operatively coupled to the control panel, the gas detector configured to detect one or more gases in the confined work space, the gas detector further configured to generate and transmit gas detection data to the CDC when the one or more gases are detected in the confined work space.

4. The system as set forth in claim 1, further comprising a communications link to the CDC, wherein the communications link is configured to facilitate transmission of one or more of the ingress data, the egress data, the internal audible communication, the internal alarm and the internal images to or from the CDC.

5. The system as set forth in claim 2, further comprising a communications link to the CDC, wherein the communications link is configured to facilitate transmission of one or more of the external audible communication and the external images to or from the CDC.

6. The system as set forth in claim 1, wherein the internal intercom system further comprises a first strobe light configured to illuminate when the internal intercom system is operating.

7. The system as set forth in claim 1, wherein the internal alarm system further comprises one or both of a first audible alarm siren and a second strobe light, both of which are configured to operate during the internal alarm.

8. The system as set forth in claim 2, wherein the external intercom system further comprises a visual indicator configured to illuminate when the external intercom system is operating.

9. The system as set forth in claim 1, wherein one or more of the control panel, the badging station, the internal intercom system, the internal alarm system and the internal camera are disposed in hazardous location-rated enclosures.

10. The system as set forth in claim 2, wherein one or more of the external intercom system and the external camera are disposed in hazardous location-rated enclosures.

11. The system as set forth in claim 2, wherein the control panel comprises:
an access controller configured for communication with the CDC;
a power over ethernet (“POE”) switch configured to operatively connect one or more of the badging station, the internal intercom system, the internal alarm system, the internal camera, the external intercom system and the external camera to the access controller;
a power supply operatively coupled to the access controller and to the POE switch; and
a back-up battery operatively coupled to the power supply.

12. The system as set forth in claim 11, wherein the access controller is disposed inside of an explosion-proof controller enclosure.

13. A method for remotely monitoring a confined work space, the method comprising:
installing a system at a work site comprising the confined work space, the system configured for remotely monitoring the confined work space, the system comprising:
a control panel configured for installation at a work site comprising the confined work space, the control panel further configured for communication with a central dispatch center (“CDC”);
a badging station operatively connected to the control panel, the badging station configured for installation external to the confined work space and proximate to an entrance to the confined work space, the badging station comprising an ingress badge reader and an egress badge reader configured for monitoring ingress and egress into and out of the confined work space, the ingress badge reader configured for generating ingress data, the egress badge reader configured for generating egress data, the badging station further configured to transmit the ingress data and the egress data to the control panel;
an internal intercom system operatively coupled to the control panel, the internal intercom system configured for installation inside of the confined work space, the internal intercom system further configured for transmitting and receiving internal audible communication with the control panel;
an internal alarm system operatively coupled to the control panel, the internal alarm system configured for installation inside of the confined work space, the internal alarm system further configured to emit an internal alarm when working conditions at the work site or in the confined work space are unsafe; and
an internal camera operatively coupled to the control panel, the internal camera configured for installation inside of the confined work space, the internal camera further configured for transmitting internal images of the confined work space to the control panel;
monitoring ingress and egress of personnel into and out of the confined work space with the badging station;
if verbal communication is to be made with the personnel in the confined work space, then communicating with the personnel via the internal intercom system; and
if working conditions at the work site or in the confined work space are unsafe, then emitting the internal alarm via the internal alarm system.

14. The method as set forth in claim 13, wherein the system further comprises:
an external intercom system operatively coupled to the control panel, the external intercom system configured for installation outside of the confined work space, the external intercom system further configured for transmitting and receiving external audible communications with the control panel; and
an external camera operatively coupled to the control panel, the external camera configured for installation outside of an entrance to the confined work space, the external camera further configured for transmitting external images to the control panel.

15. The method as set forth in claim 14, further comprising:
if verbal communication is to be made with personnel located outside of the confined work space, then communicating with said personnel via the external intercom system.

16. The method as set forth in claim 13, further comprising:
installing a gas detector proximate to the confined work space, the gas detector configured to detect one or more gases in the confined work space, the gas detector further configured to generate and transmit gas detection data to the control panel when the one or more gases are detected in the confined work space; and
if the one or more gases are detected in the confined work space by the gas detector, then transmitting the gas detection data to the CDC.

17. The method as set forth in claim 16, further comprising transmitting one or more of the ingress data, the egress data, the internal audible communication, the internal alarm, the internal images and the gas detection data to or from the CDC.

18. The method as set forth in claim 14, further comprising transmitting one or more of the external audible communication and the external images to or from the CDC.

19. The method as set forth in claim 13, wherein communicating via the internal intercom system comprises illuminating a first strobe light disposed in the confined work space.

20. The method as set forth in claim 13, wherein emitting the internal alarm comprises one or more of sounding a first audible alarm siren and illuminating a second strobe light.

21. The method as set forth in claim 14, wherein communicating via the external intercom system comprises illuminating a visual indicator.

22. The method as set forth in claim 13, wherein one or more of the control panel, the badging station, the internal intercom system, the internal alarm system and the internal camera are disposed in hazardous location-rated enclosures.

23. The method as set forth in claim 14, wherein one or more of the external intercom system and the external camera are disposed in hazardous location-rated enclosures.

24. The method as set forth in claim 14, wherein the control panel comprises:
an access controller configured for communication with the CDC;
a power over ethernet (“POE”) switch configured to operatively connect one or more of the badging station, the internal intercom system, the internal alarm system, the internal camera, the external intercom system and the external camera to the access controller;
a power supply operatively coupled to the access controller and to the POE switch; and
a back-up battery operatively coupled to the power supply.

25. The method as set forth in claim 24, wherein the access controller is disposed inside of an explosion-proof controller enclosure.
